(19) United States
(12) Patent Application Publication
(10) Pub. No.: US 2006/0259930 A1
(43) Pub. Date: Nov. 16, 2006

(54) System and method for obtaining information on digital media content

(76) Inventor: Leigh M. Rothschild, Plantation, FL (US)

Correspondence Address: CASELLA & HESPOS, 274 MADISON AVENUE, NEW YORK, NY, 10016, US

(21) Appl. No.: 11/292,613

(22) Filed: Dec. 2, 2005

Related U.S. Application Data
(63) Continuation-in-part of application No. 11/125,929, filed on May 10, 2005.

(51) Int. Cl. H04N 7/18

(52) U.S. Cl. 725/81; 725/80

(57) ABSTRACT

A system and method for obtaining information on digital media content are provided. The system and method of the present disclosure obtains information on digital media content by querying the media content through a remote server on a global computer network, e.g., the Internet, via a remote control device that uses one button for the query. The present disclosure enables a user to obtain information on media content by clicking one button on a remote control while watching or listening to the content. The user will be able to obtain specific information on the content, conduct e-commerce transactions on the content or direct specific actions by the media player or electronic device (e.g. a computer, cable box, DVD player, etc.) such as recording the content to a remote device, a portable device, or another computer on the network.

### CROSS REFERENCE TO RELATED APPLICATION

The present application is a continuation-in-part application of U.S. application Ser. No. 11/125,929, filed May 10, 2005 entitled “SYSTEM AND METHOD FOR CONTROLLING A PLURALITY OF ELECTRONIC DEVICES”, the contents of which are hereby incorporated by reference.

### BACKGROUND

1. Field

The present disclosure relates generally to control systems for electronic devices or appliances, and more particularly, to systems and methods for obtaining information on digital media content by querying the media content through a remote server on a global computer network, e.g., the Internet, via a remote control device.

2. Description of the Related Art

Various entertainment devices, e.g., televisions, digital video disc (DVD) players, VCRs, satellite receivers, etc., now litter the average home. These devices normally are operated through remote control (infrared or wireless) devices, with each entertainment device having its own remote control. Unified/universal remotes have attempted to end this ‘remote clutter’ but are limiting in design, functionality, and usefulness. Further, the unified/universal remotes are usually difficult to program and fail to have the look and feel of the original remote.

Multimedia digital content (both audio and video) is now widely played through computers that are generally Internet connected. Additionally, conventional standalone entertainment devices such as cable boxes and personal video recorders (PVRs), e.g., a Tivo™ box commercially available from Tivo™ of Alviso, Calif., are now also Internet connectable. Further, it has been announced that the new generation of high definition DVD players and recorders will also be Internet connectable.

All of the foregoing devices come with remote controls to control the digital media played on these devices. General information related to the digital media content is sometime available upon request, e.g., by selecting an info button on the associated remote control. However, this information is very limited, e.g., a title of the media content, year the media content was created, and artist performing the media content. These remote control devices will not allow the user to interrogate the entertainment device to find out specific detailed information on specific media content, such as a biography of the artist nor provide an opportunity to e-mail the artist or publisher. Further, any content that currently comes upon inquiry is from locally stored content (such as the content authored on a CD or DVD) and not content from a remote server.

Therefore, a need exists for systems and methods for enabling a user to obtain information related to digital media content being played on an electronic device via a remote control device. A further need exists for systems and methods for enabling a user to interact with the obtained information via the remote control device.

### SUMMARY

A system and method for obtaining information on digital media content are provided. The system and method of the present disclosure obtains information on digital media content by querying the media content through a remote server on a global computer network, e.g., the Internet, via a remote control device that uses one button for the query. The present disclosure enables a user to obtain information on media content, e.g. DVDs, audio or computer CDs, prerecorded video files such as Tivo™ files, personal video recorder files (PVR), etc., by clicking one button on a remote control while watching or listening to the content. The user will be able to obtain specific information on the content, conduct e-commerce transactions on the content or direct specific actions by the media player or electronic device (e.g. a computer, cable box, DVD player, etc.) such as recording the content to a remote device, a portable device, another computer on the network, etc..

According to one aspect of the present disclosure, an apparatus for obtaining information on media content includes a microprocessor configured to control at least one electronic device for playing the media content; a receiver coupled to the microprocessor for receiving an interrogate signal generated by a transmitter, wherein the microprocessor is configured for receiving the interrogate signal and generating a request to be transmitted to a remote server; and a transmission module configured to couple the apparatus to the remote server for transmitting the request to the remote server and for receiving information related to the media content from the remote server; wherein the microprocessor formats the received information to be displayed on a display device. The request includes at least one identifier read from the media content.

In another aspect, the received information is a plurality of items related to the media content and the microprocessor formats the plurality of items as a selectable list to a user, wherein at least one of the plurality of items is specific information on the media content, an e-mail address related to the media content, a web site address of the media content, option to purchase an item appearing in media content, or option to download media content to a portable device.

In a further aspect, the request includes at least one identifier read from the media content and a time the request was generated as measured from the start of the media content, wherein the received information is a plurality of items related to the media content appearing in the media content at the time the request was generated and the microprocessor formats the plurality of items as a selectable list to a user.

In another aspect, the microprocessor is configured to pause the media content, segment the content on the display device to identify at least one of the plurality of items and highlight the at least one identified items to identify to the user that information is available on the item.

According to another aspect, a remote control device for interrogating at least one portion of media content is provided. The remote control device includes at least one button for generating an interrogate signal; a microprocessor coupled to the at least one button for receiving the interrogate signal and forwarding the interrogate signal to a transmitter; and the transmitter for transmitting the interrogate signal to a controller configured to retrieve information on the at least one portion of the media content from a server over a network, wherein the transmitter transmits the interrogate signal by a wireless protocol.

In a still further aspect, a server for providing information on media content over a network includes a database including at least one table including a plurality of data fields relating to at least one media content; a processor configured to receive a request for information relating to the at least one media content, to query the database with the request and retrieve information associated with the at least one media content from the database and to transmit the retrieved information to a user.

In another aspect of the present disclosure, a method for obtaining information on media content over a network is provided. The method includes playing the media content on at least one electronic device; receiving an interrogate signal generated by a remote transmitter; generating a request to be transmitted to a remote server on the network; transmitting the request to the remote server and receiving information related to the media content from the remote server; and formatting the received information to be displayed on a display device.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a diagram of a system for controlling at least one electronic device in accordance with an embodiment of the present disclosure;

FIG. 2 is a schematic diagram of a controller in accordance with an embodiment of the present disclosure;

FIG. 3 is a schematic diagram of a transmitter in accordance with an embodiment of the present disclosure;

FIG. 4 is a flowchart illustrating a method for programming the controller;

FIG. 5 is a flowchart illustrating a method for controlling an operation of at least one electronic device in accordance with the present disclosure;

FIG. 6 illustrates several display views for describing various operations of the system of the present disclosure;

FIG. 7 illustrates a system for obtaining information on digital media content according to an embodiment of the present disclosure;

FIG. 8 is a flowchart illustrating a method for obtaining information on digital media content; and

FIG. 9 illustrates several display views of the system for obtaining information on digital media content in accordance with an embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A system and method for controlling an operation of at least one electronic device or appliance is provided. The system and method of the present disclosure obviates the need of a user of a plurality of electronic devices, e.g., a television, digital video disc (DVD) player, VCR, etc, to keep track of and maintain a corresponding plurality of remote control devices. The system and method provide a user with a graphic representation of the remote control device for each electronic appliance on a display controllable by a single, easy-to-use, intuitive transmitter. The graphic representations and associated control codes for the plurality of electronic appliances are downloadable via a global computer network, e.g., the Internet. In accordance with the present disclosure, a user can access all of the functions of each of the plurality of electronic appliances with a single remote transmitter without having to manually program the transmitter for each electronic appliance.

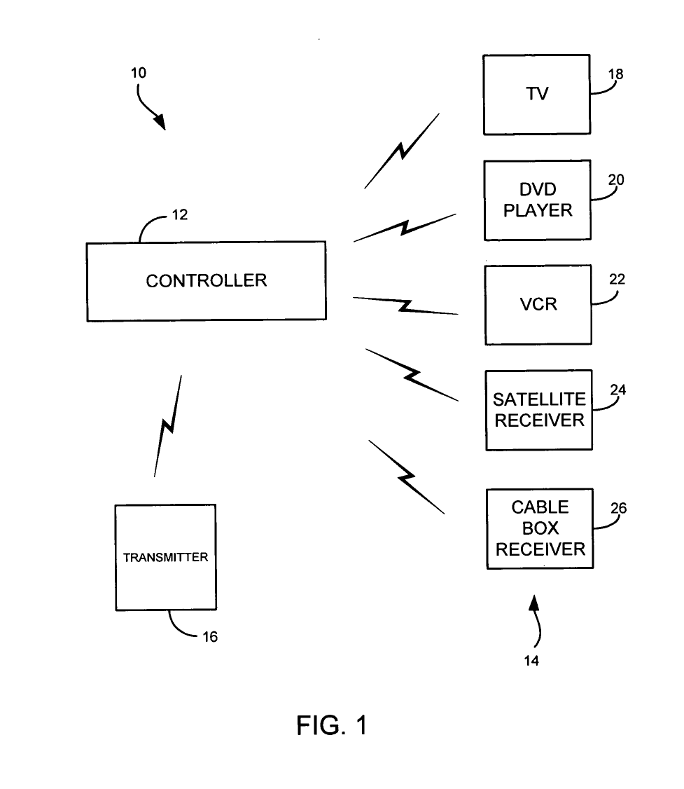

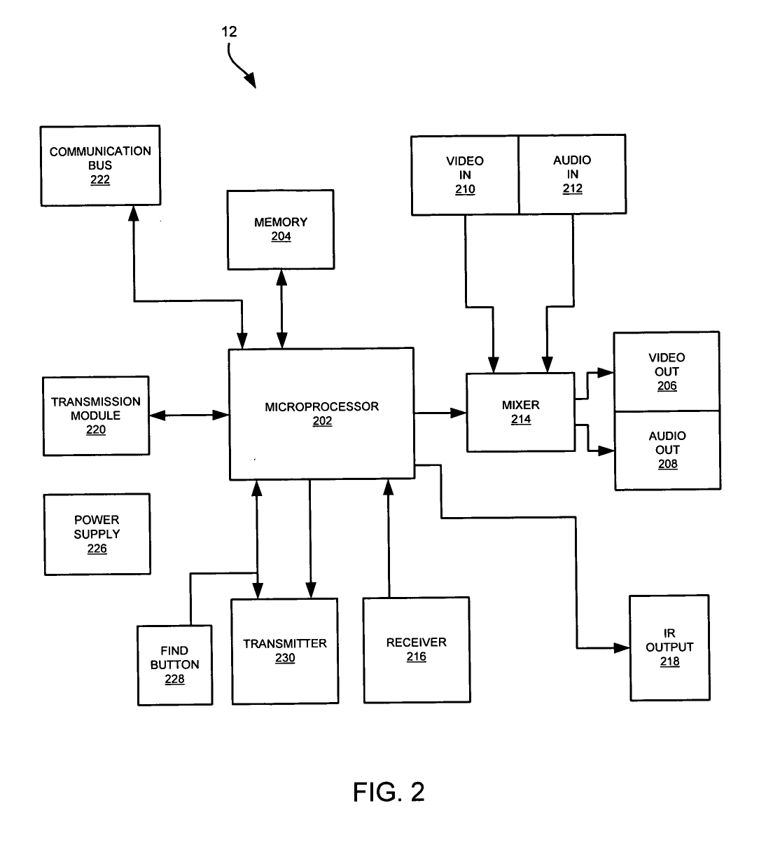

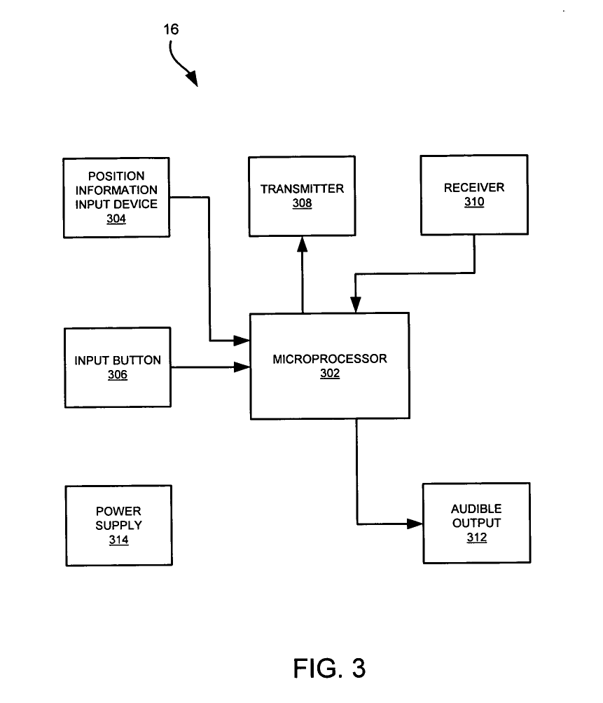

Referring to FIG. 1, a system for controlling an operation of at least one of a plurality of electronic devices or appliances is generally represented by the numeral 10. The system 10 includes a controller 12 for generating a graphic representation of at least one remote control device to be displayed on a display device, for receiving an input command relating to the at least one graphic and for generating and transmitting a control signal in response to the input command to at least one of a plurality of electronic devices 14. The electronic devices may include any known electronic appliance or component commonly employed in a home entertainment system, e.g., a television 18, a digital video disc (DVD) player 20, a VCR 22, a satellite receiver 24, a cable box receiver 26, etc. The electronic devices may further include lighting systems and computer systems. The system 10 further includes a remote control transmitter 16 for generating and transmitting command signals to the controller 12. Both the controller 12 and transmitter 16 will be described in more detail below with reference to FIGS. 2 and 3.

The controller 12 includes a microprocessor 202 for controlling the overall operations of the controller 12. A memory 204 is coupled to the microprocessor 202 and stores a plurality of graphic representations and command codes associated with a particular electronic appliance. The graphic representation is an image of the remote control device associated with a particular electronic appliance. The command codes that would normally emanate from the remote control are stored along with the graphic and will be employed to control the electronic appliance as will be described in more detail below.

A video output port 206 for outputting a video signal to a display, e.g., a television, CRT monitor, etc., and an audio output port 208 for outputting an audio signal are provided. The video output port 206 may be any known output interface including but not limited to a composite output, S-video, video graphics array (VGA), digital video interface (DVI), etc. The video output port 206 is coupled to the microprocessor 202 and receives the graphic of the remote control device and transmits the graphic to a display device. The controller 12 further includes a video input 210 and audio input 212 that are coupled to the video output port 206 and audio output port 208 via a mixer 214. In one state, the mixer 214 will receive signals from the video input 210 and audio input 212 and pass them straight through to the video output port 206 and audio output port 208. Here, the video input 210 and audio input 212 are basically pass-through jacks that mirror the original jacks, or ports, on the display device to allow a user to utilize the input jacks or ports of the display device even when the controller 12 is connected thereto. In another state, the mixer 214 will superimpose a graphic of a remote control device onto the video signal received from the video input 210. The superimposed graphic may consume the whole screen of the display device or may act as a pop-up on a small portion of the viewable area of the display.

A receiver 216 is provided for receiving positional information from the transmitter 16 and transmitting the positional information to the microprocessor 202. Once the graphic is displayed on the display, the transmitter 16 will act as a cursor control device to align a pointer over a specific function button on the remote control graphic. The receiver 216 will determine the cursor position information and send it to the microprocessor 202 which will generate a pointer in the relative position on the graphic. The receiver 216 may be a photosensor for receiving infrared signals or may be a conventional receiver operating under any of the various known wireless protocols including but not limited to Bluetooth™ interconnectivity, radio transmission connectivity including computer digital signal broadcasting and reception commonly referred to as Wi-Fi or 802.11x (where x denotes the type of transmission), or any other type of communication protocol or system currently existing or to be developed for wirelessly transmitting data.

Once a control function has been determined by the microprocessor 202 by determining the pointer location on the remote control graphic, the microprocessor will retrieve the proper control code from the memory 204 and transmit the control code to the appropriate electronic device via an infrared (IR) blaster 218, as is known in the art. An exemplary IR blaster is model IR-200L commercially available from ACTiSYS Corp. of Fremont, Calif. The infrared blaster 218 will transmit the control code via a series of infrared light pulses as would the original remote control device associated with the particular electronic appliance. The IR blaster 218 preferably is integral within a housing of the controller 12 but may located remotely from the controller to be in close proximity to the IR receiver of the particular electronic appliance.

The controller 12 further includes a transmission module 220 for coupling the controller 12 to a global computer network, e.g., the Internet, to enable data transmission between the controller 12 and other computing devices, e.g., a web server. The transmission module 220 may be but not limited to a network interface card (NIC), e.g., an Ethernet card, a WI-FI card, a Bluetooth™ transceiver, an analog/digital modem or any other known data transmission device. As will be described in more detail below, the controller 12 will access a web server during initial setup and programming and to retrieve further graphics and codes as new remote control devices are added to the system. A user will go to an established website on the Internet to register the controller 12 and existing remote control device models. A download then occurs to the controller 12 of images and bitmap charts of the remote controls selected and also the code sets for the remote control devices to be utilized with the IR blaster 218. By example if a Phillips™ remote for a VCR is registered, an image of that remote and bit map/programming would be downloaded and stored in memory in the controller 12. The controller 12 would then interpret when the transmitter 16 aligns points on the image of the remote, and subsequently, specific IR signals would be emitted from the IR blaster 218 to control the Phillips™ VCR.

The controller also includes a communication bus module 222 for coupling a plurality of controllers 12 together via a daisy-chained hardwire connection. By locating several controllers throughout a location, e.g., a home, the controllers can be located near electronic appliances located in various locations allowing a user to have control over the various electronic appliances from any controller location. The communication bus module 222 may additionally couple a plurality of infrared repeaters to the controller 12 for controlling electronic devices located remotely from the controller 12.

Optionally, the controller 12 may include a find button 228, e.g., a momentary switch, which when depressed will initiate a locate signal to the remote control transmitter 16. The find button 228 may be directly coupled to a transmitter 230 or to the transmitter 230 via the microprocessor 202. The operation of the find button and locate signal will be described in more detail below in relation to the remote control transmitter 16.

A power supply 226 is coupled to at least the above-mentioned components for supplying power to each component. Preferably, the power supply 226 is externally powered by AC current. The power supply 226 preferably also includes a battery back-up for retaining the contents of memory 204 in the event of a power supply failure.

It is to be understood that the present disclosure may be implemented in various forms of hardware, software, firmware, special purpose processors, or a combination thereof. A system bus couples the various components shown in FIG. 2 and may be any of several types of bus structures including a memory bus or memory controller, a peripheral bus, and a local bus using any of a variety of bus architectures. The system also includes an operating system and micro instruction code. The various processes and functions described herein may either be part of the micro instruction code or part of an application program (or a combination thereof) which is executed via the operating system.

It is to be further understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

In one embodiment of the present disclosure, the controller or controller components would be hardwired and resident in either a television, or another ancillary device hooked to a television or entertainment device such as a cable television control device, satellite television control device, Tivo™ or other type of personal (digital) recording device, DVD player, VCR, personal media computer, or any other type of device that is coupled to a display device or monitor.

Referring to FIG. 3, the remote control transmitter 16 of the present disclosure is illustrated. The transmitter 16 includes a microprocessor 302 for controlling the overall operations of the transmitter 16, receiving input information and generating command signals to be transmitted to the controller 12. The transmitter 16 includes a positional information input device 304, e.g., a touch pad, for generating a relative position information signal which will be transmitted to the controller 12. The positional information input device 304 will control the pointer or cursor on the display for selecting a function on the graphic of the selected remote control device. The transmitter 16 also includes at least one input button 306 for confirming selection of a control function on the graphic of the remote control. Alternatively, the user will tap the positional information input device 304 when the pointer is in the appropriate location to confirm selecting of the control function.

The microprocessor 302 will receive the input signals generated by positional information input device 304 and the at least one button 306 and will generate a command signal that will be transmitted to the controller 12 by transmitter 308. The transmitter 308 will operate under a compatible protocol with the receiver 216 of the controller 12.

The transmitter 16 will further include a receiver 310 for receiving data from the controller 12. Preferably, the receiver 310 will receive a locate signal from the controller 12 and transmit the received locate signal to the microprocessor 302 which will in turn generate a signal to activate an audible output 312, e.g., a speaker, buzzer, tone generator, etc. In this manner, upon depressing the find button 228 on the controller 12, the transmitter 16 will produce an audible sound facilitating a user locating the transmitter 16.

Furthermore, a power supply 314 is coupled to at least the above-mentioned components for supplying power to each component of the remote controller transmitter 16.

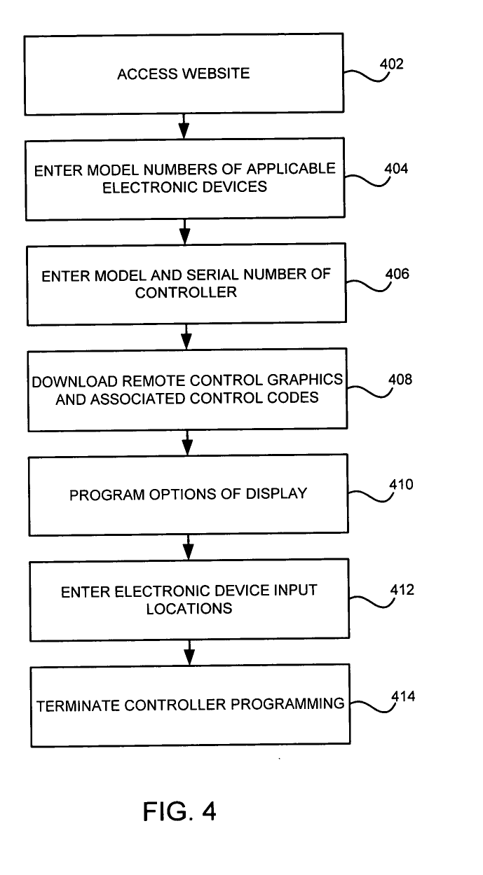

A method for programming the controller 12 will now be described with reference to FIG. 4. Initially, in step 402, a user goes to a designated website. The user will be prompted to enter the model numbers of their applicable devices, e.g., television, DVD player, etc. in a registration form (step 404). Then, in step 406, the user will be prompted to enter the model and serial number of controller 12 in their possession and to indicate a network connection of the controller 12 (and type of connection, e.g. Bluetooth™, wired, WiFi, etc). A web server then contacts the controller 12 through a local network connection and sets up the controller 12, where the microprocessor 202 is programmed with executable instructions, and software is now resident to display various remote control graphics (step 408). The control codes associated with each electronic device and/or remote control is also downloaded and stored in memory 204.

Optionally, the user may also designate any existing remote control as the remote to replace the transmitter 16 by entering at the website the model number and manufacturer of the existing remote control, and the controller 12 will then accept IR input from the designated remote control device.

In step 410, the user then tells controller 12 during setup, either through the global computer network or, alternatively at the controller 12 itself, how the remote control graphic is to be displayed during use. For example, the user will select a color of TV background, whether the graphic is a full overlay or see through overlay, a position for the pop-up graphic to appear, and size of pop-up, time for overlay to appear, tactile information (such as occurs during computer mouse setup), order for remotes to be displayed in, whether graphic remotes appear, or just keyboard remote choices. Following this step, the user may check to see if all remote controls are displayed on the screen.

Next, in step 412, the user also tells the controller 12 where each electronic device or appliance is located on the display/TV inputs, e.g. DVD is video input number one, VCR is video input 2, high def sat is dvi-1, cable is ant A, Tivo™ is input-2, etc. At this point, the controller 12 is programmed and the setup procedure is terminated (step 414). The user may now employ the single transmitter 16 to control the plurality of electronic devices.

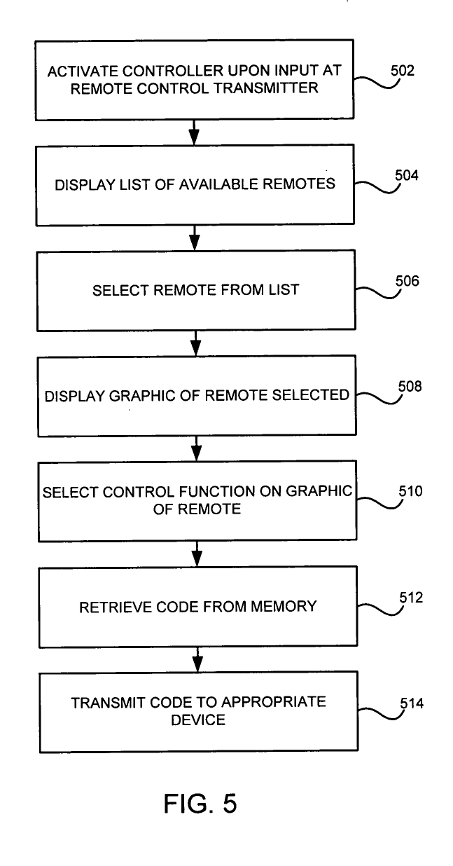

Referring to FIG. 5, a method for controlling an operation of at least one electronic device in accordance with the present disclosure is illustrated. Initially, in step 502, the user will activate the controller 12 upon any input at the remote control transmitter 16, e.g., clicking one of the buttons 306 or touching the touch pad 304. Once the user activates the controller 12, a pop up will appear, either replacing an image on the display or overlaying the image on the display, listing the remotes and/or electronic devices that have been programmed into the system (step 504). In step 506, the user can scroll down with the position information input device 304 on the remote transmitter 16 to pick the remote or device they want. Next, a remote graphic or picture of the remote selected appears (step 508).

Once the graphic of the remote is displayed, the user can then operate the selected remote through the transmitter 16 with scroll controls and button controls (step 510). Using the touch pad, the user aligns a pointer or cursor on a control button of the displayed graphic, e.g., a play button, and selects the functions with a click of the at least one button 306. The controller 12 correlates the position that the user has selected on the remote graphic, and using standard programming instructions and processing power of the microprocessor 202, the controller 12 retrieves the appropriate control code from memory 204 (step 512). Then, the controller 12 orders the IR instruction code for the position selected on the remote control to be emitted (blasted) from the IR blaster 218 to the entertainment devices. Entertainment devices are thus controlled with a single small remote transmitter 16 (or the user's existing remote if selected) and all remote control images can be resident on screen whenever they are needed. The remote transmitter can control any function available on the selected remote, e.g., change a channel, adjust volume, play a DVD, fast forward a video tape, etc.

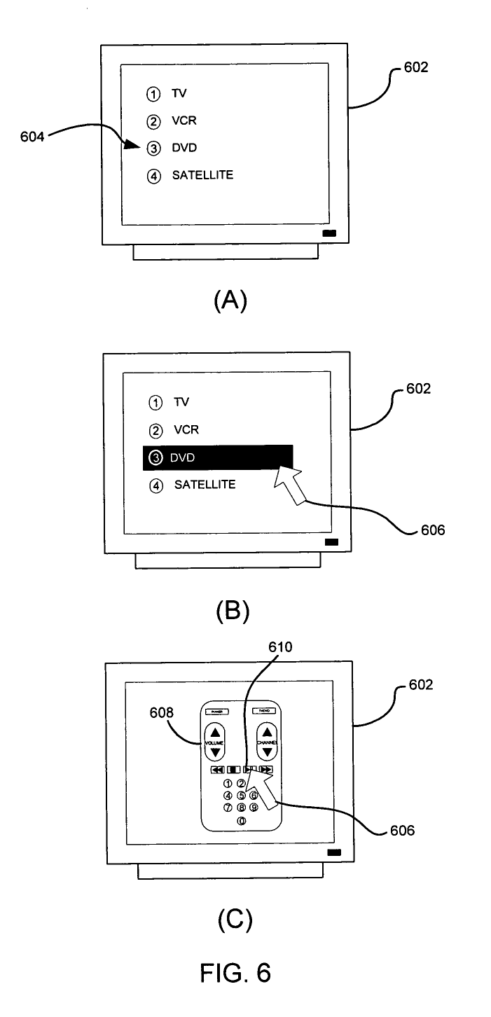

To further illustrate the operations of the system 10 of the present disclosure, FIG. 6 shows several display views generated by the system 10. Initially, the user signals the controller 12 to display a list 604 of remotes on a display device 602, e.g., a television (see FIG. 6A). Using the touch pad on the transmitter, the user moves the pointer 606 to select the DVD player (see FIG. 6B). Then, the DVD player remote appears and, at the same time, the controller 12 transits a signal via the IR blaster 218 to switch TV input to the input that the DVD player is located on, which it knows from user setup described above. The graphic 608 of the selected remote remains overlaid on the screen of the display 602 as shown in FIG. 6C. The user may then select “DVD play” on the remote graphic 608 by scrolling and then clicking on the play button 610. The controller then blasts the DVD player to start a play sequence. The user may then watch the movie and remote overlay disappears after a predetermined, user adjustable time. At a later time, the user may click the transmitter 16 and the last graphic (e.g., DVD remote) appears. The user may then scroll to and then click the pause button and the controller 12 blasts the player DVD to pause. The user may then click another button of the at least one button 306 and the list of all remotes in the system appears (FIG. 6A). The user aligns and clicks TV, and a graphic of the TV's remote pops up on screen. The user clicks the power button on the graphic of the TV remote and the TV shuts down.

In another embodiment of the present disclosure, a user can network at least one other controller 12, which is Ethernet/Bluetooth/Wi-Fi connected, to a remote display/television location. The output of the display/television would be connected to the input on the controller. The user may then from a main location also control remotely located devices such as a Tivo™ control device, etc., providing said devices have a video output. This video output would be streamed from the remote location controller to the main controller on the local computer network (either WiFi or Ethernet wiring, or Bluetooth, etc.) and the user would then see this streamed content output from the main controller video output signal which is input to the local display device.

In a further embodiment, the controller is resident in an entertainment device and, using a local or global computer network, communicates (via Wi-Fi/Bluetooth, etc. or wired) the status of the device to a user. The status information includes but is not limited to: power on/power off, audio volume, channel indication, signal frequency indication, internal temperature, power consumption, storage space, e.g., memory, for a resident digital storage device both free and utilized, sharpness of image, brightness of image, color of image, convergence aspects of display tube, etc. This information may be viewable by the user at a website or may be e-mailed to the user. Alternatively, a manufacturer of the entertainment device may receive the information and contact the user if they detect a possible malfunction with the device.

A system and method for controlling an operation of at least one electronic device, e.g., an entertainment device, has been described. The system and method of the present disclosure eliminates the need for a multitude of remote controls, simplifies the programming of a plurality of remotes into a single device, e.g., transmitter 16, is totally scalable and upgradeable, and the remote control transmitter 16 has a very small form factor.

In further embodiments of the present disclosure, a system and method for obtaining information on digital media content played on the electronic devices are provided. The system and method obtains information on the digital media content by querying the media content through a remote server on a global computer network, e.g., the Internet, via a remote control device, e.g., transmitter 16, that uses one button for the query. The system and method enables a user to obtain information on media content, e.g. DVDs, audio or computer CDs, prerecorded video files such as Tivo™ files, personal. video recorder files (PVR), etc., by clicking one button on the remote control, e.g., transmitter 16, while watching or listening to the content. The controller 12 will then query a remote server for the requested information and display this information on a display device coupled to the controller 12. The user will be able to obtain specific information on the content, conduct e-commerce transactions on the content or direct specific actions by the media player or electronic device (e.g. the computer, cable box, or DVD player, etc.) such as recording the content to a remote device, a portable device, another computer on the network, etc..

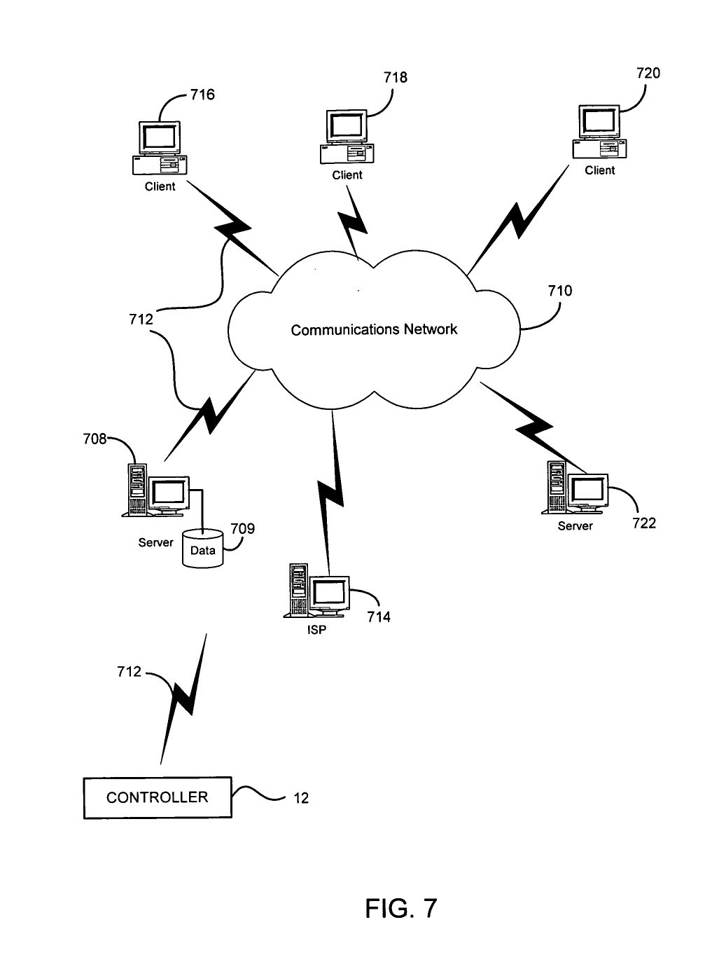

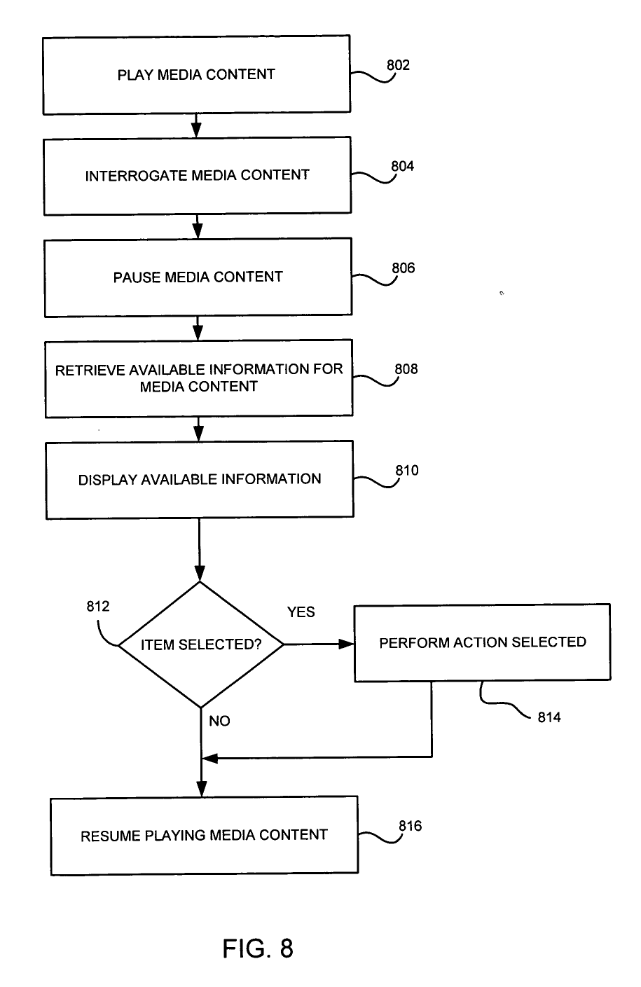

A system and method for obtaining information on digital media content by querying the media through a remote server will be described in relation to FIGS. 7 and 8. Referring to FIG. 7, the controller 12 will communicate to a remote server 708 via a communication network 710. The controller 12 and server 708 may be connected to the communications network 716, e.g., the Internet, by any known means, for example, a hardwired or wireless connection 712, such as dial-up, hardwired, cable, DSL, satellite, cellular, PCS, wireless transmission (e.g., 802.11a/b/g), etc.. It is to be appreciated that the network 710 may be a local area network (LAN), wide area network (WAN), the Internet or any known network that couples a plurality of computers to enable various modes of communication via network messages. Furthermore, the server 708 will communicate using the various known protocols such as Transmission Control Protocol/ Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc. The server 708 will further include a storage medium 709 for storing a database of information related to digital media content as will be described in more detail below.

Alternatively, the controller 12 may connect to the network 710 via an Internet Service Provider (ISP) 714, where once connected, the ISP server 714 will manage the flow of information from the controller 12, e.g., transmitting a request for information to the server 708, e-mailing to other users 716, 718, 720 of the network 710, transmitting digital media content to other computing devices, and/or manage the flow of information from various web sites connected to the network 710, e.g., content providers residing on server 722. Furthermore, the ISP 714 will include a mail server for handling electronic mail, e.g., e-mail. The mail server will include the appropriate applications and/or servers for handling incoming mail, e.g., Simple Mail Transfer Protocol (SMTP), and outgoing mail, e.g., Post Office Protocol 3 (POP3).

Although the physical environment shows the connected devices as computers, such illustration is merely exemplary and may comprise various digital devices, such as PDAs, network appliances, notebook computers, portable media centers, etc. The computing devices may communicate to the servers 708, 714, 722 and network 710 via any known communication link 712, for example, dial-up, hardwired, cable, DSL, satellite, cellular, PCS, wireless transmission (e.g., 802.11 a/b/g), etc.

Referring to FIG. 8, the controller 12 will command the appropriate electronic device to play the desired media content as described above (step 802). For example, the controller may instruct a DVD player to play a movie disc that is in the player or may instruct a digital video recorder to play a recorded movie or TV show. While the media content is playing, the user may instruct the controller 12 to interrogate or request information relating to the media content or a portion of the media content currently being played (step 804). The user will instruct the controller 12 via the transmitter 16. The transmitter 16 may be programmed so that after a play mode has been activated the input button 306 will send an interrogate signal to the controller 12 upon its next activation. Alternatively, the position information input device 304, e.g., a touch pad, will have a portion designated as the interrogate signal where upon an input an interrogate signal will be generated. Therefore, a user will be able to request information related to the media content upon activation of a single button.

Upon receiving the interrogate signal, the controller will pause the media (step 806) and will retrieve available information related to the media content from server 708 (step 808). To retrieve the information, the controller 12 will generate a request or query that will be transmitted to the remote server 708 via transmission module 220. The request will include at least one identifier of the media content, e.g., at least the title of the work, movie title, song title, etc., read from the media, e.g., read from the DVD, read from memory of the DVR where the content is stored, etc. The request may also include a time the request was generated as measured from the start of the content.

The request will be received by the server 708 and will be used to query the database 709. The database 709 will include at least one table of information including a plurality of data fields relating to at least one digital media content. The data fields may include but are not limited to date of creation, author/creator of content, publisher, web site address of creator/publisher, actor/actress featured in content, e-mail address of actor/actress, web site address of actor/actress, information on products shown in movie/TV show, etc. The database 709 may also include tables for each media content where the table is broken down into time increments and each time increment includes a plurality of data fields. The time increments represent segments of the content according to a running time of the media content measured from the start of the media content. The data fields associated with the time increments may include but are not limited to product information of a product that appeared in the segment, web site address of e-commerce site to purchase a product shown in the segment, actor/actress that appeared in the segment, web site address of a actor/actress that appeared in the segment, etc.

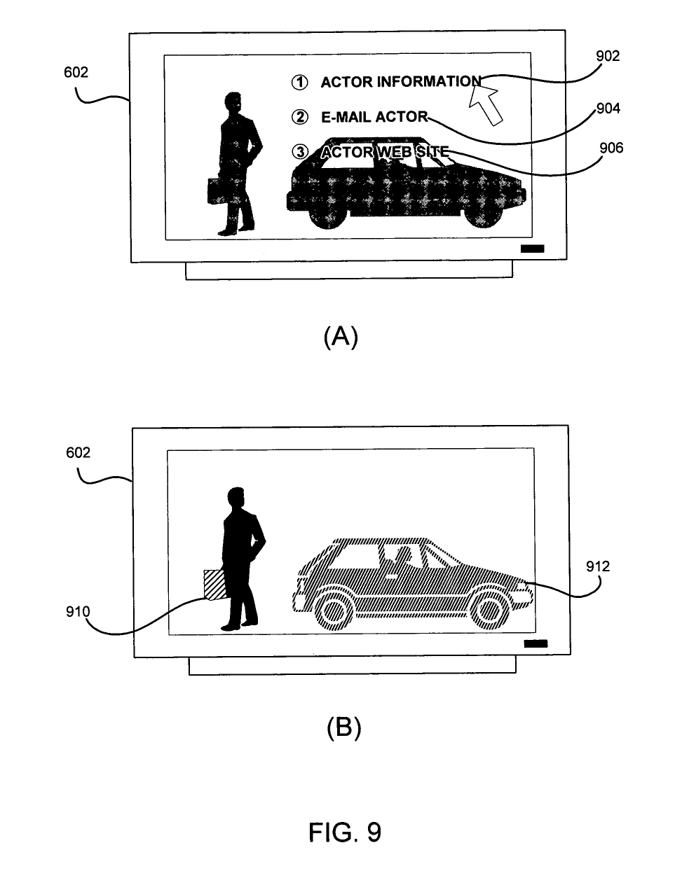

The remote server 708 will then retrieve the information associated to the media content from the database 709 and transmit the information to the controller 12 to be displayed on the display device (step 810). The controller 12 will receive the information and overlay the information over the paused content. The information may contain a plurality of items and will be displayed on the display device 602 as a list of items where the user will select an item to receive further specific information, as shown in FIG. 9A. In FIG. 9A, three items are overlaid on the paused content: actor information 902, e-mail actor 904 and actor website 906. The user will then select an item using the transmitter 16 by positioning a pointer over the item via the position information input device 304 (step 812). The user will then select the item and the controller will perform the appropriate action (step 814). For example, if the user selects actor information 902, the controller will retrieve from the remote server information on the actor such as a biography; if the user selects e-mail actor 904, the controller will access the user's e-mail program for sending an e-mail to the actor; and if the user selects actor web site 906, the controller 12 will direct the user to the web site of the actor via an appropriate web browser. After the appropriate action is preformed, controller 12 will resume playing the media content (step 816).

In another embodiment, the interrogation request will be made for a specific time of the media content, for example, when the user observes an item they are interested in. In this embodiment, the controller 12 will transmit the request to the server 708 with a time measured from the start of the media content in addition to the identifier of the media content. The server will then access the database 709 and retrieve information for that time increment. The information will then be transmitted to the controller 12 for display. The list of items will include products that are visible at the time the interrogation signal was generated. Upon selecting a product from the list, a second list will appear with specific action items for the selected product, e.g., conduct e-commerce transaction to purchase product, go to web site of product, receive e-mail regarding product, etc.

In yet another embodiment, when the a request is made for a specific time of the media content, the controller 12 will pause the media content and will highlight items on the display for which information is available. The controller 12 will receive information on the items from server 708 and, using image segmentation as is known in the art, will identify the items in the paused image on the display, segment the items and highlight the items to distinguish to a user that information is available on that item. Referring to FIG. 9B, the display device 602 illustrates the paused media content with several items highlighted, e.g., a briefcase 910 and car 912. In FIG. 9B, the items with hatched lines represent highlighted items. The user will then select one of the highlighted items and will be presented with a list of action items as described above.

Examples of applications for the present disclosure are as follows:

A user is watching a DVD movie. The user wants to find out who the actor is in a specific scene in the movie. The user presses the interrogate button, e.g., position information input device 304 or input button 306, on the remote control device, e.g., transmitter 16. The controller 12 then places the media in a freeze frame mode, e.g., a pause mode, with text of information retrieved from the remote server overlaying the movie on the display device. The text would then prompt the user if he wants to know information on the actor. The user would then click on the same button of the transmitter 16 and would receive that information with possibly other options including going to a personal web site of the actor. When the user is through with the query, the user would press the play button on his remote control and the media would continue.

A user is watching a digitally recorded television show on his personal digital video recorder (DVR) device (such as a Tivo™ box or a cable PVR). The user sees a commercial slot and is interested in the product being shown in the commercial. The user presses the interrogate button, e.g., position information input device 304 or input button 306, on his remote control device, e.g., transmitter 16. The controller 12 then places the media in a freeze frame mode, with text of information retrieved from the remote server overlaying the commercial slot on the display device. The controller would then prompt the user if he wants to know information on the product. The user would then click on the same button on the transmitter and would receive that information with possibly other options including going to a global computer network site, e.g., Internet web site. The user could also select to receive e-mail on the product which could be directed to go to the users registered e-mail address. When the user is through with the query, the user would press the play button on his remote control device and the media would continue.

A user is watching a digitally recorded television show on his personal digital video recorder (DVR) device (such as a Tivo™ box or a cable PVR). The user is interested in sending (e.g., downloading) this media content to his portable media device (such as the Creative™ Zen media device, Samsung Yep or Video Ipod™). The user presses the interrogate button, e.g., position information input device 304 or input button 306, on the remote control device, e.g., transmitter 16. The controller 12 then places the media in a freeze frame mode, with text options overlaying the television show on the display device. The controller would then prompt the user if he wants to download this media content to his portable device. The user would then click on the same button of the transmitter to select the download portable device or just click if a default portable device has been pre-selected. When the user is through with the query, the user would press the play button on his remote control and the media would continue.

A user is listening to an audio compact disc (CD) on his DVD player or on a computer. The user wants to find out who the drummer is playing in the background. The user presses the interrogate button, e.g., position information input device 304 or input button 306, on the remote control device, e.g., transmitter 16. The controller 12 then places the media in a freeze frame mode, with text of information retrieved from the remote server now appearing on any content previously on the screen of the display device (such as the visualization graphics or screen savers that frequently appear when playing music on a computer). The controller 12 would then prompt the user if he wants to know information on the artist. The user would then click on the same button of the transmitter and would receive that information with possibly other options including going to a global computer network site, e.g., an Internet web site. When the user is through with the query, the user would press the play button on his remote control and the media would continue.

A user is watching a DVD movie. The user wants to find out what the actress is wearing in a specific scene in the movie. The user presses the interrogate button, e.g., position information input device 304 or input button 306, on the remote control device, e.g., transmitter 16. The controller 12 then places the media in a freeze frame mode, with the text of information retrieved from the remote server overlaying the movie on the display device. The controller 12 would then prompt the user if he wants to know information on the actress' attire. The user would then click on the same button of the transmitter 16 and would receive that information with possibly other options including going to an Internet web site to conduct an e-commerce transaction to purchase the particular item. Alternatively, the controller would cause items available for purchase to be highlighted, where the user would simply select a highlighted item via the transmitter 16 and be transferred to an e-commerce web site to purchase the item. When the user is through with the query, the user would press the play button on his remote control and the media would continue.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. An apparatus for obtaining information on media content, the apparatus comprising:
a microprocessor configured to control at least one electronic device for playing the media content;
a receiver coupled to the microprocessor for receiving an interrogate signal generated by a transmitter, wherein the microprocessor is configured for receiving the interrogate signal and generating a request to be transmitted to a remote server; and
a transmission module configured to couple the apparatus to the remote server for transmitting the request to the remote server and for receiving information related to the media content from the remote server;
wherein the microprocessor formats the received information to be displayed on a display device.

2. The apparatus of claim 1, wherein the request includes at least one identifier read from the media content.

3. The apparatus of claim 1, wherein the received information is a plurality of items related to the media content and the microprocessor formats the plurality of items as a selectable list to a user.

4. The apparatus of claim 3, wherein at least one of the plurality of items is specific information on the media content, an e-mail address related to the media content, a web site address of the media content, option to purchase an item appearing in media content, or option to download media content to a portable device.

5. The apparatus of claim 3, wherein upon selection of at least one of the plurality of items, the microprocessor presents a second plurality of items to the user.

6. The apparatus of claim 1, wherein the request includes at least one identifier read from the media content and a time the request was generated as measured from the start of the media content.

7. The apparatus of claim 1, wherein the received information is a plurality of items related to the media content appearing in the media content at the time the request was generated and the microprocessor formats the plurality of items as a selectable list to a user.

8. The apparatus of claim 7, wherein the microprocessor is further configured to pause the media content, segment the content on the display device to identify at least one of the plurality of items and highlight the at least one identified items to identify to the user that information is available on the item.

9. The apparatus of claim 1, wherein the transmitter comprises a position information input device for generating the interrogate signal.

10. The apparatus of claim 9, wherein the position information input device is a touch pad.

11. The apparatus of claim 1, wherein the transmitter comprises at least one button for generating the interrogate signal.

12. The apparatus of claim 1, wherein the transmitter transmits the interrogate signal by a wireless protocol.

13. The apparatus of claim 12, wherein the wireless protocol is infrared signals, Bluetooth interconnectivity, radio frequency interconnectivity or computer digital signal broadcasting and reception interconnectivity.

14. A remote control device for interrogating at least one portion of media content, the remote control device comprising:
at least one button for generating an interrogate signal;
a microprocessor coupled to the at least one button for receiving the interrogate signal and forwarding the interrogate signal to a transmitter; and
the transmitter for transmitting the interrogate signal to a controller configured to retrieve information on the at least one portion of the media content from a server over a network.

15. The remote control device of claim 14, wherein the transmitter comprises a position information input device for generating the interrogate signal.

16. The remote control device of claim 15, wherein the position information input device is a touch pad.

17. The remote control device of claim 15, wherein the position information input device is configured to select an option of the retrieved information.

18. The remote control device of claim 14, wherein the at least one button is a touch pad.

19. The remote control device of claim 14, wherein the transmitter transmits the interrogate signal by a wireless protocol.

20. The remote control device of claim 19, wherein the wireless protocol is infrared signals, Bluetooth interconnectivity, radio frequency interconnectivity or computer digital signal broadcasting and reception interconnectivity.

21. The remote control device of claim 14, where the controller further comprises a microprocessor configured to control at least one electronic device for playing the media content; a receiver coupled to the microprocessor for receiving the interrogate signal generated by the transmitter of the remote control device, wherein the microprocessor is configured for receiving the interrogate signal and generating a request to be transmitted to the server; and a transmission module configured to couple the controller to the server for transmitting the request to the server and for receiving information related to the media content from the remote server; wherein the microprocessor formats the received information to be displayed on a display device.

22. A server for providing information on media content over a network, the server comprising:
a database including at least one table including a plurality of data fields relating to at least one media content;
a processor configured to receive a request for information relating to the at least one media content, to query the database with the request and retrieve information associated with the at least one media content from the database and to transmit the retrieved information to a user.

23. The server of claim 22, wherein the request includes at least one identifier read from the media content.

24. The server of claim 22, wherein at least one data field is date of creation, author/creator of content, publisher, web site address of creator/publisher, actor/actress featured in content, e-mail address of actor/actress, web site address of actor/actress or, information on products shown in movie/TV show.

25. The server of claim 22, wherein the database further includes at least one table for the at least one media content where the table is broken down into time increments and each time increment includes a plurality of data fields, the time increments representing segments of the at least one media content according to a running time of the media content measured from the start of the media content.

26. The server of claim 25, wherein at least one data field is product information of a product that appeared in a segment, web site address of e-commerce site to purchase a product shown in a segment, actor/actress that appeared in a segment or web site address of a actor/actress that appeared in the segment.

27. The server of claim 26, wherein the request includes at least one identifier read from the media content and a time the request was generated as measured from the start of the media content.

28. A method for obtaining information on media content over a network, the method comprising:
playing the media content on at least one electronic device;
receiving an interrogate signal generated by a remote transmitter;
generating a request to be transmitted to a remote server on the network;
transmitting the request to the remote server and receiving information related to the media content from the remote server; and
formatting the received information to be displayed on a display device.

29. The method of claim 28, wherein the request includes at least one identifier read from the media content.

30. The method of claim 28, wherein the received information is a plurality of items related to the media content, further comprising formatting the plurality of items as a selectable list to a user.

31. The method of claim 30, wherein at least one of the plurality of items is specific information on the media content, an e-mail address related to the media content, a web site address of the media content, option to purchase an item appearing in media content, or option to download media content to a portable device.

32. The method of claim 30, wherein upon selection of at least one of the plurality of items, further comprising presenting a second plurality of items to the user.

33. The method of claim 28, wherein the request includes at least one identifier read from the media content and a time the request was generated as measured from the start of the media content.

34. The method of claim 28, wherein the received information is a plurality of items related to the media content appearing in the media content at the time the request was generated, further comprising formatting the plurality of items as a selectable list to a user.

35. The method of claim 34, further comprising pausing the media content, segmenting the content on the display device to identify at least one of the plurality of items and highlighting the at least one identified items to identify to the user that information is available on the item.
